(19) United States
(12) Patent Application Publication
(10) Pub. No.: US 2009/0188138 A1
(43) Pub. Date: Jul. 30, 2009

(54) Indicator System for Portable Linear Structures

(76) Inventor: Kevin Murphy, Morgan Hill, CA (US)

Correspondence Address: COURTNEY STANIFORD & GREGORY LLP, P.O. BOX 9686, SAN JOSE, CA, 95157, US

(21) Appl. No.: 12/356,884

(22) Filed: Jan. 21, 2009

Related U.S. Application Data
(60) Provisional application No. 61/023,464, filed on Jan. 25, 2008.

(51) Int. Cl. G09F 3/00; G09F 9/00

(52) U.S. Cl. 40/316; 116/278

(57) ABSTRACT

An indicator system is provided that comprises an indicator positioned on a linear structure. The linear structure includes a portable linear structure having a proximal end and a distal end. The linear structure includes, for example, at least one of a hose, a fire hose, a cable, an electrical cable, a rope, a strap, and a tether device. The indicator includes directional markers positioned along the linear structure and oriented to identify a path to the proximal end. Each of the directional markers comprises a shape of an arrow, and a tip of the arrow points along the path to the proximal end. Additionally, the indicator can include a text string, for example, a text string comprising a word meaning “EXIT” or other similar term or phrase.

### RELATED APPLICATION

This application claims the benefit of U.S. Patent Application No. 61/023,464, filed Jan. 25, 2008.

### TECHNICAL FIELD

This application relates to signals and indicators.

### BACKGROUND

Exiting from a region like a structure (e.g., building, ship, etc.), forest, or other terrain under conditions of low visibility can be challenging. As an example, firefighters in a burning building are required to negotiate their exit from the building by navigating through the building under conditions of low visibility caused by smoke from the burning structure. The low visibility can endanger lives because it can make a timely and expeditious exit from the building difficult if not nearly impossible.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF DRAWINGS

FIG. 1 is a block diagram of a system including a line and an indicator system, under an embodiment.

FIG. 2 shows an indicator system, under an embodiment.

FIG. 3 shows an indicator for orientation to and affixing to a line, under an embodiment.

FIG. 4 shows media including two indicators and media including more than two indicators, under an embodiment.

FIG. 5 is a cross-sectional view of a system including a line and an indicator system, under an embodiment.

### DETAILED DESCRIPTION

An indicator system is described below that comprises an indicator or indicator device positioned on a linear structure. The linear structure includes a portable linear structure having a proximal end and a distal end. The linear structure includes, for example, at least one of a hose, a fire hose, a cable, an electrical cable, a rope, a strap, and a tether device. The indicator includes directional markers positioned along the linear structure and oriented to identify a path to the proximal end. Each of the directional markers comprises a shape of an arrow, and a tip of the arrow points along the path to the proximal end. The directional marker is not limited to comprising arrow-shaped indicators or markers, and other embodiments can include directional markers of any shape or symbol. Additionally, the indicator can include a text string, for example, a text string comprising a word meaning “EXIT” or other similar term or phrase.

Furthermore, a device is described below comprising a line and an indicator system positioned on the line. The line comprises a portable linear structure having a proximal end and a distal end. The proximal end of the line is configured to connect to a source fixture (e.g., outlet, supply terminal or source, valve, turnbuckle, etc.) at an exterior of a region, and the distal end of the line is configured to deploy to an interior of the region such that the line defines a path at least partially through the interior of the region when the distal end is deployed. The region can include one or more of a structure, a building, a forest, area of terrain, and a body of water, but is not so limited. The indicator system includes at least one directional indicator oriented to indicate a direction along the path to the exterior of the region.

In the following description, numerous specific details are introduced to provide a thorough understanding of, and enabling description for, embodiments of the present invention. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

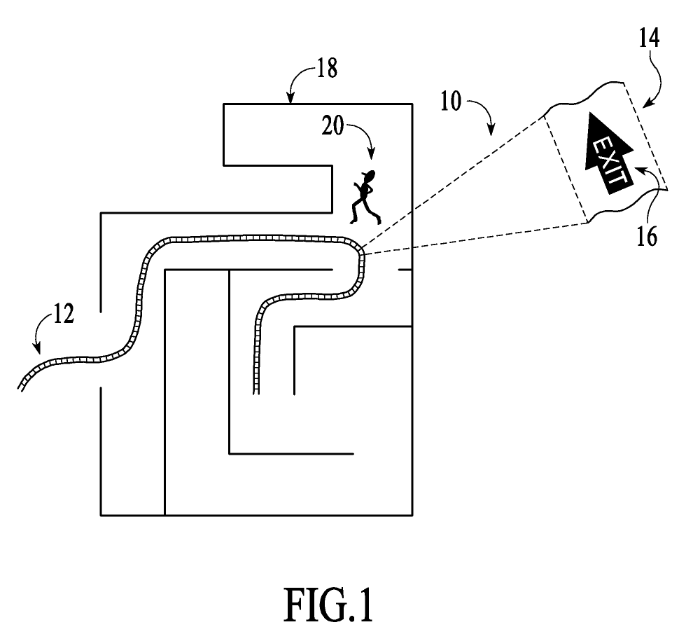

FIG. 1 is a block diagram of a system 10 including a line 12 and an indicator system 14, under an embodiment. The indicator system 14 may also be referred to herein as an indicator, an indicator device, or a device. The device 14 is affixed to or included as a component of the line 12, and the device 14 includes a directional indicator 16. The device 14 may be oriented and affixed on the line 12 to enable an exit. The line 12 may be embodied as a hose, a fire hose, a cable, an electrical cable, a rope, a strap, a tether, or any other portable longitudinal structure that may signal or form a path. The line 12 of this example is shown to be lying on the corridors of a building 18 and emerging from an opening of the building 18 into an open area such that a person 20 may use the directional indicator 16 to identify a direction for following the line 12 to exit from the building 18; however, the embodiments herein are not limited to lines 12 in building corridors. For example, the person 20 may identify a right turn is necessary to exit the building 18 based on the orientation of the device 14 relative to the line 12. Accordingly, proper orientation of the device 14 to the line 12 positions the directional indicator 16 to enable an identification of a direction to follow the line 12 to exit from the building 18.

The line 12 may be embodied as a fire hose that may be carried into a building to extinguish a fire. Accordingly, the system 10 may enable exit from the building notwithstanding damage to the structure and reduced visibility that may be caused by smoke.

The line 12 may further be embodied as an electrical cable that may be carried into a building to provide power. For example, the power may be provided for tools necessary for construction or remodeling. Accordingly, the system 10 may enable exit from a building with little or no knowledge of a floor plan of the building.

In yet another embodiment the line 12 may be extended outside through terrain that obstructs visibility. For example, the line 12 may be extended in a forest sufficiently dense to impair the ability of fire fighters to find their way to the water source of the line 12.

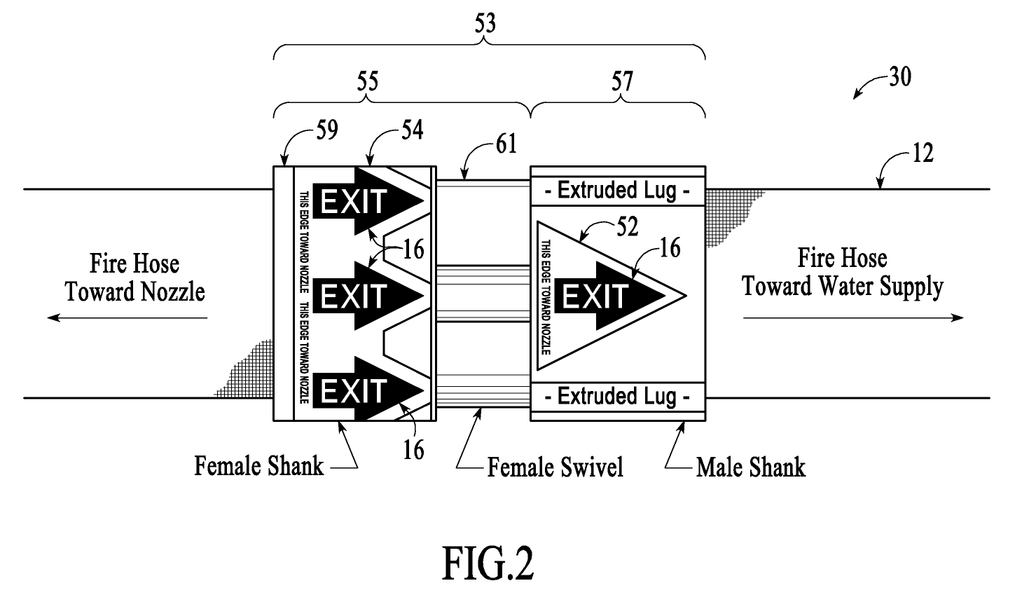

FIG. 2 shows an indicator system 50, under an embodiment. The indicator system 50 is shown used with a line 12 in the form of a fire hose that may be carried into a building or through an area or region of terrain, however, as described above, the line 12 is not limited to being a fire hose but instead can be any portable linear structure. The fire hose may include a coupling 53 that further includes a female member 55 and a male member 57. The female member 55 may include a female shank 59 and a female swivel 61.

The male member 57 in the form of a male shank is shown to include a device 52 that includes a directional indicator 16. The device 52 has been oriented and affixed to the male member 57 to enable a person to identify a path for exit. In another embodiment the device 52 may be oriented and affixed to the female swivel 61 or the female shank 59 to enable a person to identify a path for exit.

The female shank 59 is further shown to include a device 54 that includes multiple directional indicators 16. The device 54 has been oriented and affixed to the female shank 59 to enable a person to identify a path for exit. In another embodiment the device 54 may be oriented and affixed to the female swivel 61 or the male shank 57 to enable a person to identify a path for exit.

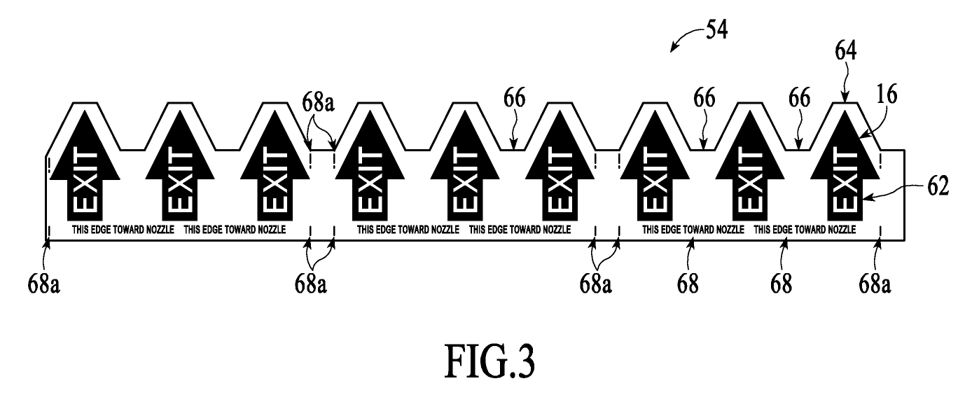

FIG. 3 shows an indicator 54 for orientation to and affixing to a line 12, under an embodiment. The line 12 of an embodiment is a fire hose, but the embodiment is not so limited. The indicator 54 is shown to include multiple directional indicators 16 respectively including a text string 62, “EXIT.” In another embodiment the text string 62 may be duplicated and oriented to enable reading in both directions. The text string 62 and 68 can include any text and/or phrase in any language (e.g., English, German, Spanish, French, Hebrew, Japanese, Chinese, Farsi, etc.) and is not limited to particular text in a particular language. The indicator 54 is further shown to include a cut 64 that traces a serrated edge around the points of the arrows that may provide an obvious point visible from a distance. A cut-in 66 of the cut 64 may be a short length cut, running parallel to the long edge of the indicator 54 to create a saddle in the base of the cut 64, thus giving distinction to enhance visibility from a distance. A cut-in 66 of the cut 64 may also facilitate interlocking the indicator 54 for efficiency in production. A text string 68 behind the arrow, along the long edge, opposite the serrated edge, may read “THIS EDGE TOWARD NOZZLE” so as to signify proper orientation to facilitate affixing the indicator 54 on a fire hose in relation to the direction of a water supply. The indicator 54 may further be scaled to fit couplings of various sizes. A series of datum marks 68a may show where indicator 54 may be cut to facilitate placement on the shank of the male coupling.

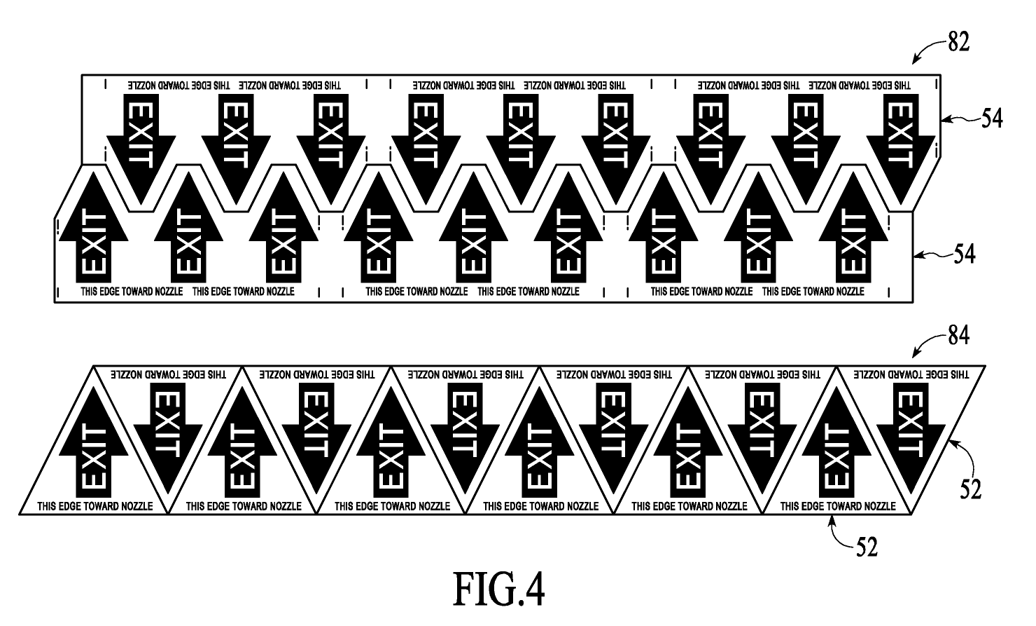

FIG. 4 shows media 82 including two indicators 54 and media 84 including more than two indicators 52, under an embodiment. In one embodiment, the media 82, 84 may be affixed to the line 12 by way of mechanical weave into the line 12, or other method of attachment. In one embodiment, the media 82, 84 may also respectively include a fastening surface that may include a pressure sensitive adhesive layer to enable affixing of the media 82, 84 to the line 12. For example, the line 12 may be embodied as a fire hose and the adhesive layer may enable affixing of the media 82, 84 to a coupling 53 on the fire hose, or the fire hose itself. Additionally, the line 12 may be embodied as a fire hose and the adhesive layer may enable affixing of the media 82, 84 to an identification collar on the fire hose, where an example of the identification collar is shown and described in U.S. Pat. No. 6,079,135.

In one embodiment, the media 82, 84 may also respectively include a visible surface that may be of bright colors and/or reflective to facilitate identification of a direction to follow the line 12 notwithstanding impaired visibility. In another embodiment, the media 82, 84 may also include a visible surface that may be of photoluminescent material capable of being energized by an artificial or natural light source, thereby emitting a glow of light for an extended period of time, independent of the original light source. In another embodiment the media 82, 84 may be of vinyl type, or an equivalent, with all weather capability to resist wear caused by low and high temperatures. In another embodiment the media 82, 84 may include an appropriate clear laminate layer over the visible surface of the media to facilitate print and to resist wear caused by abrasion, and provide a raised, tactile surface. The media 82, 84 of an embodiment comprises any adhesive capable material, and may be of bright colors, and/or reflective and/or photoluminescent. Specifically, any reflective material up to and including any of the American Society for Testing and Materials (ASTM International) standards for levels of reflectivity for traffic safety signs (e.g., ASTM Type IX). As one example, the media 82, 84 comprises 3M brand, 3983 Diamond Grade VIP Fluorescent, Yellow Green reflective material or the equivalent. The media 82, 84 may also comprise 3M Process Color Series 880I ink, or equivalent, printed on the appropriate clear laminate layer. The media 82, 84 may also comprise a photoluminescent ink process, or equivalent, printed on the clear laminate layer.

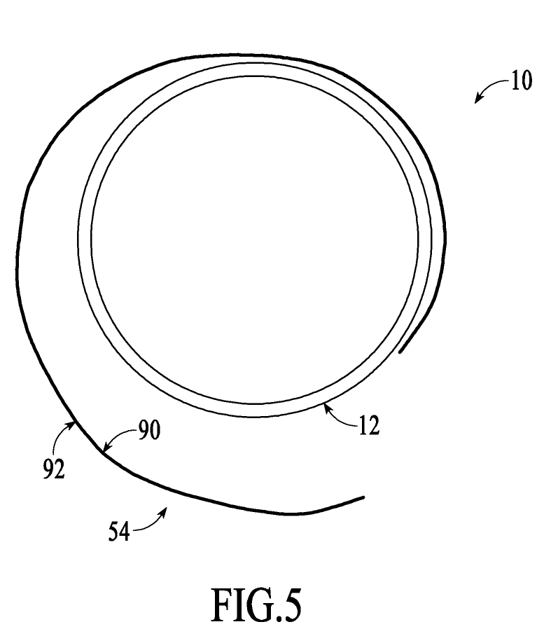

FIG. 5 is a cross-sectional view of a system including a line and an indicator system, under an embodiment. The system 10 includes a line 12 and device 54 that is being affixed to the line 12. The device 54 may include a pressure sensitive adhesive fastening surface 90, and a visible surface 92, as previously described.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the corresponding systems and methods is not intended to be exhaustive or to limit the systems and methods to the precise forms disclosed. While specific embodiments of, and examples for, the embodiments and corresponding systems and methods are described herein for illustrative purposes, various equivalent modifications are possible within the scope of the systems and methods, as those skilled in the relevant art will recognize. The teachings of the embodiments and corresponding systems and methods provided herein can be applied to other systems and methods, not only for the systems and methods described above.

The elements and acts of the various embodiments described above can be combined to provide further embodiments. These and other changes can be made to the embodiments and corresponding systems and methods in light of the above detailed description.

In general, in the following claims, the terms used should not be construed to limit the embodiments and corresponding systems and methods to the specific embodiments disclosed in the specification and the claims, but should be construed to include all systems that operate under the claims. Accordingly, the embodiments and corresponding systems and methods are not limited by the disclosure, but instead the scope is to be determined entirely by the claims.

While certain aspects of the embodiments and corresponding systems and methods are presented below in certain claim forms, the inventors contemplate the various aspects of the embodiments and corresponding systems and methods in any number of claim forms. Accordingly, the inventors reserve the right to add additional claims after filing the application to pursue such additional claim forms for other aspects of the embodiments and corresponding systems and methods.

What is claimed is:

1. A device comprising:
a line, the line comprising a portable linear structure having a proximal end and a distal end, wherein the proximal end is configured to connect to a source fixture at an exterior of a region, wherein the distal end is configured to deploy to an interior of the region such that the line defines a path at least partially through the interior of the region when the distal end is deployed; and
an indicator system positioned on the line, the indicator system comprising at least one directional indicator oriented to indicate a direction along the path to the exterior of the region.

2. The device of claim 1, wherein the line is at least one of a hose, a fire hose, a cable, an electrical cable, a rope, a strap, and a tether device.

3. The device of claim 1, wherein the indicator system is affixed to the line.

4. The device of claim 1, wherein the indicator system is a component of the line.

5. The device of claim 1, wherein the directional indicator includes a marker having a shape of an arrow, wherein a tip of the arrow points to the direction along the path to the exterior of the region.

6. The device of claim 5, wherein the directional indicator includes a text string, the text string comprising a word meaning “EXIT”.

7. The device of claim 5, wherein the directional indicator comprises a reflective material.

8. The device of claim 5, wherein the directional indicator comprises a photoluminescent material.

9. The device of claim 1, wherein the directional indicator includes a symbol, wherein the symbol indicates a direction along the path to the exterior of the region.

10. The device of claim 1, wherein the directional indicator includes a plurality of markers, wherein each marker has a shape of an arrow, wherein a tip of the arrow points to the direction along the path to the exterior of the region.

11. The device of claim 1, wherein the indicator system includes a plurality of directional indicators positioned in a plurality of locations along the line, wherein each directional indicator of the plurality of directional indicators includes at least one marker having a shape of an arrow, wherein a tip of the arrow points to the direction along the path to the exterior of the region.

12. The device of claim 1, wherein the line is a fire hose comprising at least one coupling, wherein the indicator system is positioned on the at least one coupling.

13. An indicator system comprising an indicator positioned on a linear structure, the linear structure comprising a portable linear structure having a proximal end and a distal end, the indicator comprising a plurality of directional markers positioned along the linear structure and oriented to identify a path to the proximal end, wherein each directional marker of the plurality of the directional markers comprises a shape of an arrow, wherein a tip of the arrow points along the path to the proximal end.

14. The indicator system of claim 13, wherein the linear structure is a fire hose comprising at least one coupling, wherein the indicator is positioned on the at least one coupling.

15. A method comprising:
forming an indicator comprising a plurality of directional markers, each directional marker of the plurality of the directional markers having a shape of an arrow; and
positioning the indicator on a linear structure, the linear structure comprising a portable linear structure having a proximal end and a distal end, the positioning comprising positioning the plurality of directional markers along the linear structure and orienting the plurality of directional markers to identify a path to the proximal end, wherein a tip of the arrow of each directional marker of the plurality of the directional markers points along the path to the proximal end.

16. The method of claim 15, comprising affixing the indicator to the linear structure.

17. The method of claim 15, comprising forming the linear structure to include the indicator as a component of the linear structure.

18. The method of claim 15, comprising forming the indicator to include a text string comprising a word meaning “EXIT”.

19. The method of claim 18, wherein the text string comprises a photoluminescent ink.

20. The method of claim 15, wherein forming the indicator comprises forming the indicator of reflective material.

21. The method of claim 15, wherein forming the indicator comprises forming the indicator of photoluminescent material.

22. The method of claim 15, wherein forming the indicator comprises forming the indicator of non-reflective material.

23. The method of claim 15, wherein the linear structure is a fire hose comprising at least one coupling, wherein positioning the indicator on the linear structure includes positioning the indicator on at least one coupling.

24. The method of claim 15, wherein the linear structure is at least one of a hose, a fire hose, a cable, an electrical cable, a rope, a strap, and a tether device.
